(19) United States
(12) Patent Application Publication
(10) Pub. No.: US 2026/0064061 A1
(43) Pub. Date: Mar. 5, 2026

(54) IMAGE FORMING APPARATUS

(71) Applicant: SHARP KABUSHIKI KAISHA, Sakai City (JP)

(72) Inventor: Hidenobu MANDAI, Sakai City (JP)

(21) Appl. No.: 19/307,398

(22) Filed: Aug. 22, 2025

(30) Foreign Application Priority Data
Aug. 30, 2024 (JP) 2024-148084

(51) Int. Cl. G03G 15/00; H04N 1/00

(52) U.S. Cl. CPC G03G 15/5016; H04N 1/00496; H04N 2201/006; H04N 2201/0063

(57) ABSTRACT

An image forming apparatus includes: a housing that houses an image former that forms an image on a sheet; an operation panel that is provided at an edge of an upper surface of the housing so as to be rotatable such that an operation surface that receives an operation of a user is inclined in an up-down direction; and a short-range wireless communicator that is provided on the upper surface of the housing and performs wireless communication with a mobile terminal. The short-range wireless communicator is provided on the upper surface of the housing in a range in which the mobile terminal does not come into contact with the operation panel when the mobile terminal is brought close to the short-range wireless communicator.

### CROSS-REFERENCE TO RELATED APPLICATION

The present application claims priority from Japanese Application JP2024-148084, the content of which is hereby incorporated by reference into this application.

### BACKGROUND OF THE INVENTION

### 1. Field of the Invention

The present disclosure relates to an image forming apparatus.

### 2. Description of the Related Art

In the related art, an image forming apparatus including an operation panel has been proposed. In the image forming apparatus disclosed in the related art, a short-range wireless communicator that performs wireless communication with a mobile terminal is provided in an operation panel.

### SUMMARY

However, in the above-described related art, when communication is performed between the mobile terminal and the short-range wireless communicator, the mobile terminal may touch an operation key of the operation panel and cause malfunction.

An object of an aspect of the present disclosure is to provide an image forming apparatus in which malfunction of an operation panel can be prevented.

An image forming apparatus according to an aspect of the present disclosure includes a housing that houses an image former that forms an image on a sheet, an operation panel that is provided at an edge of an upper surface of the housing so as to be rotatable such that an operation surface that receives an operation of a user is inclined in an up-down direction, and a short-range wireless communicator that is provided on the upper surface of the housing and performs wireless communication with a mobile terminal, wherein the short-range wireless communicator is provided on the upper surface of the housing in a range in which the mobile terminal does not come into contact with the operation panel when the mobile terminal is brought close to the short-range wireless communicator.

According to an aspect of the present disclosure, in an image forming apparatus, malfunction of an operation panel can be prevented.

### BRIEF DESCRIPTION OF THE DRAWINGS

FIG. 1 is a diagram illustrating an example of an image forming apparatus according to an embodiment of the present disclosure.

FIG. 2 is a diagram illustrating the example of the image forming apparatus according to the embodiment of the present disclosure.

FIG. 3 is a diagram illustrating the example of the image forming apparatus according to the embodiment of the present disclosure.

FIG. 4 is an enlarged view of a B portion in the image forming apparatus illustrated in FIG. 2.

FIG. 5 is a schematic view illustrating an example of an internal structure of a main body illustrated as an A portion of the image forming apparatus illustrated in FIG. 1.

### DETAILED DESCRIPTION OF THE INVENTION

Embodiments and modifications of the present disclosure will be described below with reference to the accompanying drawings. Note that in the following description, the same or corresponding members are denoted by the same reference numerals throughout the drawings, and duplicated description thereof will be omitted. Further, the embodiment and the modifications described below are merely examples of the present disclosure, and the present disclosure is not limited to the embodiment and the modifications. Even in cases other than the embodiments and the modifications, various changes can be made according to design and the like without departing from the technical idea of the present disclosure.

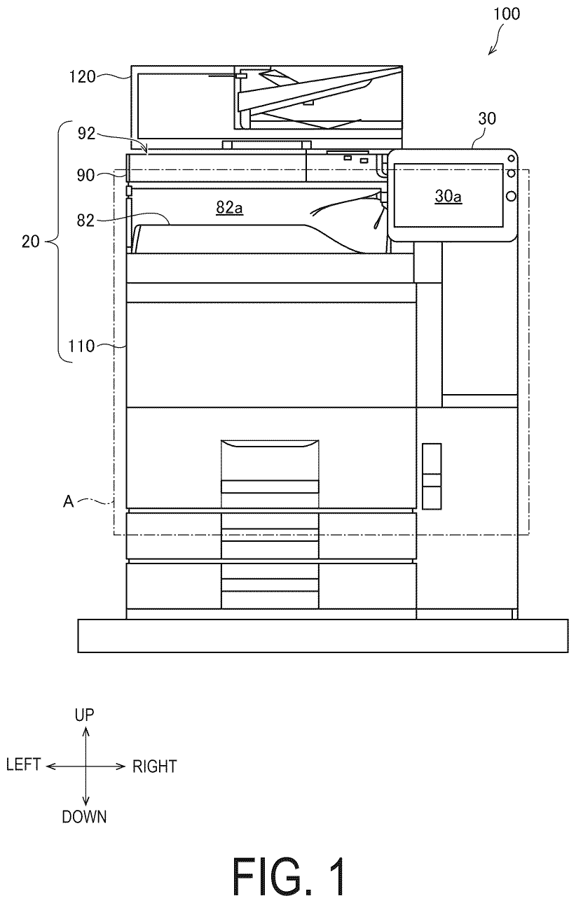

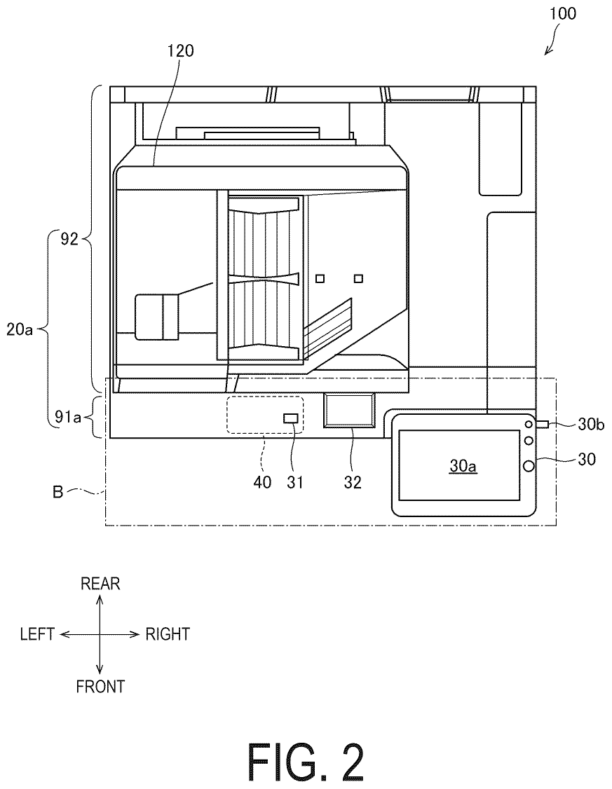

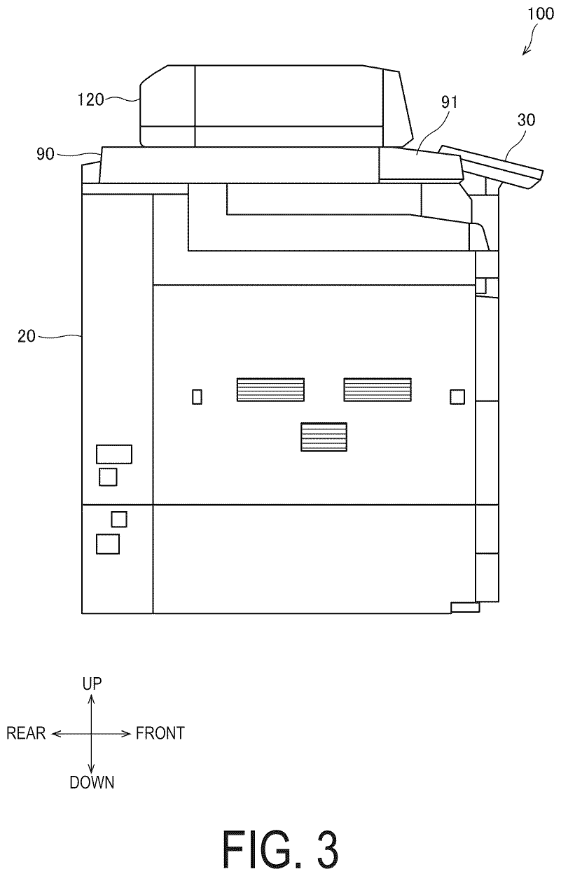

An image forming apparatus 100 according to an embodiment of the present disclosure will be described with reference to FIGS. 1 to 3. FIGS. 1 to 3 are each a diagram illustrating an example of the image forming apparatus 100 according to the embodiment of the present disclosure. FIG. 1 is a diagram of the image forming apparatus 100 as viewed from a front surface toward a rear surface. FIG. 2 is a diagram of the image forming apparatus 100 as viewed from an upper surface toward a lower surface. FIG. 3 is a diagram of the image forming apparatus 100 as viewed from a left side surface toward a right side surface.

Note that in the image forming apparatus 100, when viewed from the front surface to the rear surface, a left side and a right side in a horizontal direction are defined as a left direction and a right direction, respectively. Further, in the image forming apparatus 100, a bottom side and an opposite side are defined as a lower direction and an upper direction, respectively. Further, in the image forming apparatus 100, when viewed from the front surface toward the rear surface, a front surface side in a depth direction is referred to as a front side, and a rear surface side is referred to as a rear side.

The image forming apparatus 100 is a laser type color printer that forms a multicolor or monochrome image on a sheet. The image forming apparatus 100 can print an image on a sheet based on image data read from a document by a document reading device 90 or image data received from an outside. Note that in the embodiment, a laser type color printer is described as an example of the image forming apparatus 100, but the present disclosure is not limited to this.

As illustrated in FIG. 1, the image forming apparatus 100 is configured to include a main body including the document reading device 90, a document table 92, and an image former 110, and an automatic document feeding device 120. The main body is housed inside a housing 20.

The image former 110 prints an image on a sheet based on, for example, image data read from a document by the document reading device 90 or image data received from the outside. Although details will be described below, the image former 110 includes an exposure unit 1, a developing unit 2, a photoreceptor drum 3, a cleaning unit 4, a charger 5, an intermediate transfer belt unit 6, a fixing unit 7, a sheet feeding cassette 81, and a sheet discharge tray 82.

An upper portion of the image former 110 is provided with the sheet discharge tray 82 and a hollow internal 82a which is a cavity provided above the sheet discharge tray 82, and a sheet on which an image is printed is discharged onto the sheet discharge tray 82. The sheet discharged onto the sheet discharge tray 82 is accumulated in the hollow internal 82a. The sheet accumulated in the hollow internal 82a can be taken out by a user inserting his/her hand into the hollow internal 82a.

An upper portion of the hollow internal 82a is provided with the document reading device 90 and the document table 92 including a transparent glass. Further, the automatic document feeding device 120 is mounted above the document table 92.

An edge of a front end of a housing upper surface 20a, which is on the front surface side of the housing 20 and is an upper surface of the housing 20, is provided with an operation panel 30. The operation panel 30 is a so-called tilt type operation panel that is provided to be rotatable such that an operation surface 30a that receives an operation of a user is inclined in an up-down direction.

More specifically, as illustrated in FIG. 3, an upper portion of the housing 20 is configured with the document reading device 90 including an upper surface provided with the document table 92, and a protruding portion 91 protruding forward from the document reading device 90.

Then, as illustrated in FIG. 2, an upper surface of the document table 92 provided above the document reading device 90 and a protruding portion upper surface 91a which is an upper surface of the protruding portion 91 are flush with each other, and the upper surface of the document table 92 and the protruding portion upper surface 91a form the housing upper surface 20a. Then, the automatic document feeding device 120 is disposed above the document table 92, and the document table 92 is covered with the automatic document feeding device 120. On the other hand, the protruding portion upper surface 91a is provided with the operation panel 30, the short-range wireless communicator 31, and a recessed portion 32.

The short-range wireless communicator 31 performs data communication in a non-contact manner between a mobile terminal 40 (see FIG. 2) carried by a user and the image forming apparatus 100, and is a communicator for which, for example, a near field communication (NFC) technology is used. Note that in FIG. 2, for convenience of description, only an outer shape of the mobile terminal 40 is indicated by a broken line. For example, the user can establish communication between the mobile terminal 40 and the image forming apparatus 100 by bringing the mobile terminal 40 close to the short-range wireless communicator 31 or placing the mobile terminal 40 above the short-range wireless communicator 31. Then, the mobile terminal 40 can transmit image data and the like to the image forming apparatus 100.

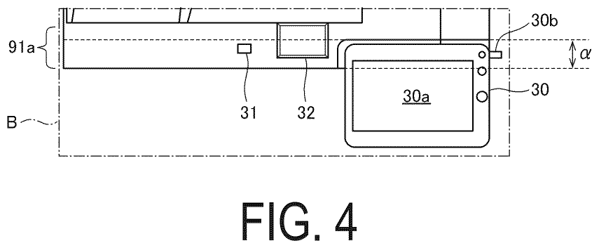

Hereinafter, an arrangement relationship between the operation panel 30 and the short-range wireless communicator 31 will be specifically described with reference to FIG. 4. FIG. 4 is an enlarged view of the B portion in the image forming apparatus 100 illustrated in FIG. 2.

The operation panel 30 is provided on a right side of an edge of a front end of the protruding portion upper surface 91a so as to be rotatable about a rotary shaft 30b extending along the edge of the front end of the protruding portion upper surface 91a. Then, a configuration is adopted in which the operation panel 30 rotates such that the operation surface 30a can be inclined in the up-down direction.

On the other hand, the short-range wireless communicator 31 is provided on the protruding portion upper surface 91a in a range in which the mobile terminal 40 does not come into contact with the operation panel 30 when the user brings the mobile terminal 40 close to the short-range wireless communicator 31. It is preferable that other operation buttons and the like different from the operation panel 30 are not provided in a vicinity of a region where the short-range wireless communicator 31 is provided. Further, as illustrated in FIG. 2, the short-range wireless communicator 31 is provided forward the document table 92.

To be more specific, the short-range wireless communicator 31 is provided at a center in a left-right direction of the protruding portion upper surface 91a and within a range (within a range of a in FIG. 4) in which the operation panel 30 is disposed as viewed from the front end of the protruding portion upper surface 91a in the depth direction. Note that a size of the protruding portion upper surface 91a in the depth direction is such a size that the mobile terminal 40 carried by the user can be placed thereon.

As described above, the short-range wireless communicator 31 is provided in the range where the mobile terminal 40 does not come into contact with the operation panel 30, and thus, it is possible to prevent the mobile terminal 40 from erroneously hitting the operation panel 30 and causing malfunction when the mobile terminal 40 is brought close to the short-range wireless communicator 31. Further, since the short-range wireless communicator 31 is provided forward the document table 92, it is possible to prevent the mobile terminal 40 placed above the short-range wireless communicator 31 from becoming an obstacle when a document is set on the document table 92.

Further, since the short-range wireless communicator 31 is provided on the left side of the operation panel 30, the user can bring the mobile terminal 40 close to the short-range wireless communicator 31 with a left hand while performing an operation on the operation panel 30 with a right hand. Therefore, operability of the image forming apparatus 100 for the user is improved.

Further, since the short-range wireless communicator 31 is provided at the center in the left-right direction of the protruding portion upper surface 91a, a configuration can be adopted in which the operation panel 30 is provided on the left side of the protruding portion upper surface 91a, that is, on the left side of the short-range wireless communicator 31 depending on design specifications of the image forming apparatus 100.

Further, the short-range wireless communicator 31 is provided within the range in which the operation panel 30 is disposed in the depth direction of the protruding portion upper surface 91a. Therefore, when the user visually recognizes the operation panel 30 and the short-range wireless communicator 31 together, a movement range of a line of sight of the user can be reduced. Therefore, when the operation panel 30 and the short-range wireless communicator 31 are operated at the same time, visibility for the user can be improved.

Additionally, as illustrated in FIG. 3, an inclination angle of the protruding portion upper surface 91a provided with the short-range wireless communicator 31 with respect to a horizontal plane is smaller than an inclination angle of the operation surface 30a of the operation panel 30 with respect to the horizontal plane when an operation is received from the user. Further, the inclination angle of the protruding portion upper surface 91a with respect to the horizontal plane is an angle at which the mobile terminal 40 does not slip down along the inclination when the mobile terminal 40 is placed on the protruding portion upper surface 91a.

As described above, since the short-range wireless communicator 31 is provided not on the operation panel 30 but on the protruding portion upper surface 91a, an inclination angle of a region where the short-range wireless communicator 31 is provided does not vary according to a variation of the inclination angle of the operation surface 30a of the operation panel 30. Further, the inclination angle of the protruding portion upper surface 91a is smaller than the inclination angle of the operation surface 30a of the operation panel 30 when an operation is received from the user. In particular, the inclination angle of the protruding portion upper surface 91a is the angle at which the mobile terminal 40 does not slip down along the inclination when the mobile terminal 40 is placed.

Therefore, the user can incline the operation surface 30a of the operation panel 30 at a desired inclination angle and operate the operation panel 30, while the mobile terminal 40 is placed in the region where the short-range wireless communicator 31 is provided.

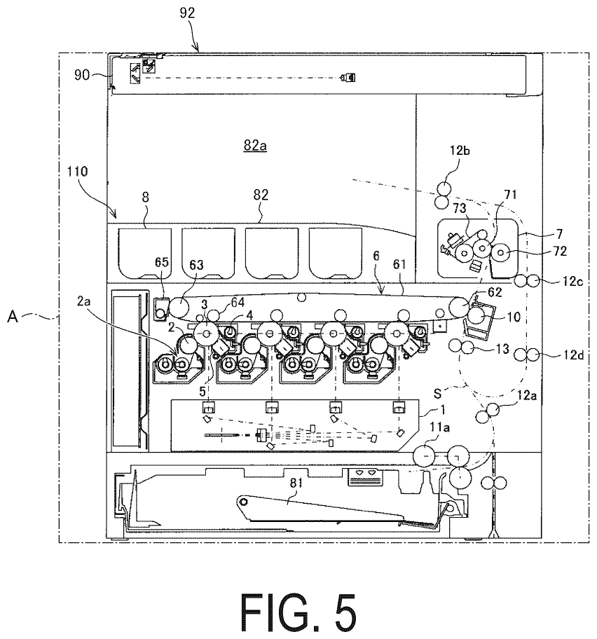

Additionally, as illustrated in FIGS. 1 and 4, the region where the short-range wireless communicator 31 is provided on the protruding portion upper surface 91a is located above the hollow internal 82a, and is not at a position that comes into contact with a member that generates high heat, such as the fixing unit 7 (see FIG. 5 described below). Therefore, in the image forming apparatus 100, it is possible to prevent the short-range wireless communicator 31 from being broken down due to heat.

Additionally, as illustrated in FIG. 4, the recessed portion 32 is provided between the operation panel 30 and the short-range wireless communicator 31. An IC (non-contact type) card reader may be disposed in the recessed portion 32. At this time, an IC card can be placed in the recessed portion 32 and read. The recessed portion 32 holds the IC card so as not to slip down. Further, even when an IC card reader is not mounted, the recessed portion 32 separates the operation panel 30 and the short-range wireless communicator 31 by a predetermined interval. The user can prevent the mobile terminal 40 from being brought closer to the operation panel 30 than necessary by using the recessed portion 32 as a mark. Further, the user can also position the portable terminal 40 with reference to the recessed portion 32 and place the mobile terminal 40 at an appropriate position above the short-range wireless communicator 31. In addition, when the placed mobile terminal 40 overlaps the recessed portion 32, a gap is formed between the mobile terminal 40 and the protruding portion upper surface 91a, and the mobile terminal 40 is easily handled when lifted.

Next, an internal structure of the main body of the image forming apparatus 100 will be described with reference to FIG. 5. FIG. 5 is a schematic view illustrating an example of the internal structure of the main body illustrated as the A portion of the image forming apparatus 100 illustrated in FIG. 1.

As illustrated in FIG. 5, the main body of the image forming apparatus 100 includes the document reading device 90, the document table 92, and the image former 110.

The document reading device 90 reads image data from a document conveyed or placed on the document table 92. The image former 110 prints an image on a sheet based on the image data read by the document reading device 90.

The image former 110 includes the exposure unit 1, the developing unit 2, the photoreceptor drum 3, the cleaning unit 4, the charger 5, the intermediate transfer belt unit 6, the fixing unit 7, the sheet feeding cassette 81, and the sheet discharge tray 82.

The image data handled in the image forming apparatus 100 corresponds to a color image in which each color of cyan (C), magenta (M), yellow (Y), and black (K) is used. Accordingly, four of the developing units 2, four of the photoreceptor drums 3, four of the cleaning units 4, and four of the chargers 5 are provided to form four types of latent images corresponding to the respective colors.

The charger 5 uniformly charges a front surface of the photoreceptor drum 3 to a predetermined potential. As the charger 5, a charger of a charger type, a contact type, a brush type, or the like can be used.

The exposure unit 1 is configured as a laser scanning unit (LSU) including a laser emitter, a reflection mirror, and the like. The exposure unit 1 includes a polygon mirror that performs scanning with a laser beam, and an optical member such as a lens or a mirror for guiding laser light reflected by the polygon mirror to the photoreceptor drum 3. The exposure unit 1 exposes the charged photoreceptor drum 3 according to the image data to form an electrostatic latent image according to the image data on the front surface thereof.

The developing unit 2 visualizes the electrostatic latent image formed on the photoreceptor drum 3 with toner. The visualization with the toner forms a toner image on the photoreceptor drum 3. The developing unit 2 includes a development tank 2a, and the toner is stored in the development tank 2a. The developing unit 2 is configured such that the toner stored in the development tank 2a is supplied to the photoreceptor drum 3. Further, the development tanks 2a are connected to toner cartridges 8 storing the toner via toner feed pipes (not illustrated), respectively. The toner cartridges 8 are provided for the toner of four colors, respectively.

The cleaning unit 4 removes and collects the toner residual on a front surface of the photoreceptor drum 3 after development and image transfer.

The intermediate transfer belt unit 6 is disposed above the photoreceptor drum 3. The intermediate transfer belt unit 6 includes an intermediate transfer belt 61, an intermediate transfer belt driving roller 62, an intermediate transfer belt driven roller 63, four intermediate transfer rollers 64, and an intermediate transfer belt cleaning unit 65. The four intermediate transfer rollers 64 are provided corresponding to respective colors of K, Y, M, and C.

The intermediate transfer belt driving roller 62, the intermediate transfer belt driven roller 63, and the four intermediate transfer rollers 64 each rotate the intermediate transfer belt 61 in a tensioned state.

The intermediate transfer roller 64 applies a transfer bias for transferring the toner image of the photoreceptor drum 3 onto the intermediate transfer belt 61, and presses the photoreceptor drum 3.

The intermediate transfer belt 61 is provided so as to come in contact with each photoreceptor drum 3. Then, a color toner image (multicolor toner image) is formed on the intermediate transfer belt 61 by sequentially superimposing and transferring the toner images of the respective colors formed on the photoreceptor drums 3 onto the intermediate transfer belt 61. The intermediate transfer belt 61 is formed in an endless shape using a film having a thickness of about 100 μm to 150 μm, for example.

The toner image is transferred from the photoreceptor drum 3 to the intermediate transfer belt 61 by the intermediate transfer roller 64 that is in contact with a back side of the intermediate transfer belt 61. A high-voltage transfer bias (a high voltage having a polarity (+) opposite to a charge polarity (−) of the toner) is applied to the intermediate transfer roller 64 in order to transfer the toner image. The intermediate transfer roller 64 is a roller including, as a base, a metal (e.g., stainless steel) shaft having a diameter of 8 mm to 10 mm and a conductive elastic material (e.g., EPDM, urethane foam, or the like) covering a surface of the shaft. With this conductive elastic material, a high voltage can be uniformly applied to the intermediate transfer belt 61.

The electrostatic latent images visualized according to respective color phases on the respective photoreceptor drums 3 are layered on the intermediate transfer belt 61, and are transferred onto a sheet by a transfer roller 10 disposed at a contact position between the sheet and the intermediate transfer belt 61.

At this time, the intermediate transfer belt 61 and the transfer roller 10 are brought into pressure contact with each other at a predetermined nip, and a voltage (a high voltage having the polarity (+) opposite to the charge polarity (−) of the toner) for transferring the toner onto the sheet is applied to the transfer roller 10.

Further, as described above, the toner adhering to the intermediate transfer belt 61 by coming into contact with the photoreceptor drum 3 or the toner remaining on the intermediate transfer belt 61 without being transferred onto the sheet by the transfer roller 10 causes color mixing of the toner in a subsequent step. Thus, this toner is removed and collected by the intermediate transfer belt cleaning unit 65.

The intermediate transfer belt cleaning unit 65 includes, for example, a cleaning blade as a cleaning member that comes into contact with the intermediate transfer belt 61. Note that a surface of the intermediate transfer belt 61 opposite to a surface coming in contact with the cleaning blade is supported by the intermediate transfer belt driven roller 63.

The sheet feeding cassette 81 is a tray for accumulating sheets to be used for image printing, and is provided below the exposure unit 1 of the image former 110.

The image former 110 is further provided with the sheet discharge tray 82. The sheet discharge tray 82 stacks a printed sheet facedown.

Further, the image former 110 is provided with a sheet conveying path S for feeding the sheets from the sheet feeding cassette 81 to the sheet discharge tray 82 via the transfer roller 10 and the fixing unit 7. Pickup rollers 11a and 11b, a plurality of conveying rollers 12a to 12d, a registration roller 13, the transfer roller 10, the fixing unit 7, and the like are disposed along the sheet conveying path S from the sheet feeding cassette 81 to the sheet discharge tray 82.

The conveying rollers 12a to 12d are small rollers for assisting the conveyance of the sheet, and a plurality of the conveying rollers are provided along the sheet conveying path S. The pickup roller 11a is provided in a vicinity of an end portion of the sheet feeding cassette 81 to pick up the sheets one by one from the sheet feeding cassette 81 and supply the sheets to the sheet conveying path S.

The registration roller 13 temporarily holds the sheet being conveyed on the sheet conveying path S. The registration roller 13 conveys the sheet to the transfer roller 10 at a timing at which a leading end of the toner image on the intermediate transfer belt 61 and a leading end of the sheet are aligned.

The fixing unit 7 includes a heat roller 71 and a pressure roller 72, and the heat roller 71 and the pressure roller 72 rotate with the sheet interposed therebetween. Further, the heat roller 71 is set to a predetermined fixing temperature based on a signal from a temperature detector (not illustrated). Then, the heat roller 71 and the pressure roller 72 thermally press the toner to the sheet. Thus, the fixing unit 7 can melt, mix, and press a multicolor toner image transferred onto the sheet, thereby thermally fixing the multicolor toner image onto the sheet. Note that the fixing unit 7 is provided with an external heating belt 73 for heating the heat roller 71 from the outside.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus, comprising:
a housing that houses an image former that forms an image on a sheet;
an operation panel that is provided at an edge of an upper surface of the housing so as to be rotatable such that an operation surface that receives an operation of a user is inclined in an up-down direction; and
a short-range wireless communicator that is provided on the upper surface of the housing and performs wireless communication with a mobile terminal, wherein
the short-range wireless communicator is provided on the upper surface of the housing in a range in which the mobile terminal does not come into contact with the operation panel when the mobile terminal is brought close to the short-range wireless communicator.

2. The image forming apparatus according to claim 1, wherein
a recessed portion is formed between the operation panel and the short-range wireless communicator on the upper surface of the housing.

3. The image forming apparatus according to claim 1, wherein
an inclination angle of a region where the short-range wireless communicator is provided on the upper surface of the housing with respect to a horizontal plane is smaller than an inclination angle of the operation panel with respect to the horizontal plane when an operation is received from the user.

4. The image forming apparatus according to claim 1, wherein
the short-range wireless communicator is provided at a center position in a left-right direction of the housing when the housing is viewed from a front side toward a rear side.
